(19) United States
(12) Patent Application Publication
(10) Pub. No.: US 2025/0085798 A1
(43) Pub. Date: Mar. 13, 2025

(54) DISPLAY PANEL AND DISPLAY DEVICE

(71) Applicant: Everdisplay Optronics (Shanghai) Co., Ltd., Shanghai (CN)

(72) Inventors: Hongli LIU, Shanghai (CN); Zhao WANG, Shanghai (CN)

(73) Assignee: Everdisplay Optronics (Shanghai) Co., Ltd., Shanghai (CN)

(21) Appl. No.: 18/728,090

(22) PCT Filed: Apr. 17, 2023
(86) PCT No.: PCT/CN2023/088675

§ 371 Date: Jul. 11, 2024

(30) Foreign Application Priority Data
Dec. 6, 2022 (CN) 202223269402.0

(51) Int. Cl. G06F 3/041

(52) U.S. Cl. CPC G06F 3/0412; G06F 3/0416

(57) ABSTRACT

Disclosed in embodiments of the present application are a display panel and a display device. The display panel includes: an array substrate, a cover plate, and a touch driver board; the cover plate is arranged on the array substrate, a side of the cover plate away from the array substrate includes a touch driver board binding area, the touch driver board binding area includes a first binding area and a second binding area, and the first binding area and the second binding area are arranged in a stepped mode; the touch driver board includes a first conductive part and a second conductive part, the first conductive part is exposed, the second conductive part is not exposed, the first conductive part is arranged in the first binding area and part of the second binding area, and the second conductive part is arranged in the second binding area.

### CROSS REFERENCE TO RELATED APPLICATION

The present application is a U.S. National Stage of International Application No. PCT/CN2023/088675, filed on Apr. 17, 2023, which claims the benefit of priority to Chinese Application No. 202223269402.0, filed on Dec. 6, 2022, both of which are incorporated by reference herein in its entirety.

### TECHNICAL FIELD

The embodiments of the present disclosure relate to the technical field of display panels, and in particular, to a display panel and a display device.

### BACKGROUND

In order to meet people's needs, electronic devices can achieve more and more functions. For example, wearable display devices need to have better corrosion resistance. However, the internal binding structure of the display screen of some wearable display devices cannot use the conventional back-side glue coating process to prevent corrosion caused by moisture, salt spray, etc., which will result in poor water resistance and salt spray resistance of the display screen of the display device.

### SUMMARY

According to a first aspect of embodiments of the present disclosure, there is provided a display panel, including an array substrate, a cover plate and a touch driver board;
the cover plate is arranged on the array substrate, and a side of the cover plate away from the array substrate includes a touch driver board binding area, the touch driver board binding area includes a first binding area and a second binding area, and the first binding area and the second binding area are arranged in a stepped mode; and
the touch driver board includes a first conductive part and a second conductive part, the first conductive part is exposed, the second conductive part is not exposed, the first conductive part is arranged in the first binding area and part of the second binding area, and the second conductive part is arranged in the second binding area.

According to a second aspect of embodiments of the present disclosure, there is provided a display device, including the display panel according to any embodiments of the present disclosure.

### BRIEF DESCRIPTION OF THE DRAWINGS

In order to more clearly illustrate the technical solutions in the embodiments of the present application, the following is a brief introduction to the drawings required for the description of the embodiments. Obviously, the drawings described below are only some embodiments of the present application. For those skilled in the art, other drawings can be obtained based on these drawings without creative work.

FIG. 1 is a cross-sectional view of a display panel provided by the prior art;

FIG. 2 is a cross-sectional view of a display panel provided by an embodiment of the present application:

FIG. 3 is a cross-sectional view of a touch driver board provided by an embodiment of the present application;

FIG. 4 is a cross-sectional view of another display panel provided by an embodiment of the present application:

FIG. 5 is a cross-sectional view of another display panel provided by an embodiment of the present application:

FIG. 6 is a top view of a display panel provided by an embodiment of the present application:

FIG. 7 is a cross-sectional view of another display panel provided by an embodiment of the present application;

FIG. 8 is a schematic diagram of a structure of a display device provided by an embodiment of the present application.

### DETAILED DESCRIPTION

In order to enable those skilled in the art to better understand the solution of the present application, the technical solution in the embodiment of the present disclosure will be clearly and completely described below in conjunction with the drawings in the embodiment of the present application. Obviously, the described embodiment is only a part of the embodiment of the present application, not all of the embodiments. Based on the embodiments in the present application, all other embodiments obtained by those skilled in the art without creative work should belong to the scope of protection of the present disclosure.

It should be noted that the terms “first”, “second”, etc. in the specification and claims of the present disclosure and the above-mentioned drawings are used to distinguish similar objects, and are not necessarily used to describe a specific order or sequence. It should be understood that the data used in this way can be interchangeable where appropriate, so that the embodiments of the present disclosure described here can be implemented in an order other than those illustrated or described here. In addition, the terms “including” and “having” and any of their variations are intended to cover non-exclusive inclusions. For example, a process, method, system, product or device that includes a series of steps or units is not necessarily limited to those steps or units clearly listed, but may include other steps or units that are not clearly listed or inherent to the process, method, product or device.

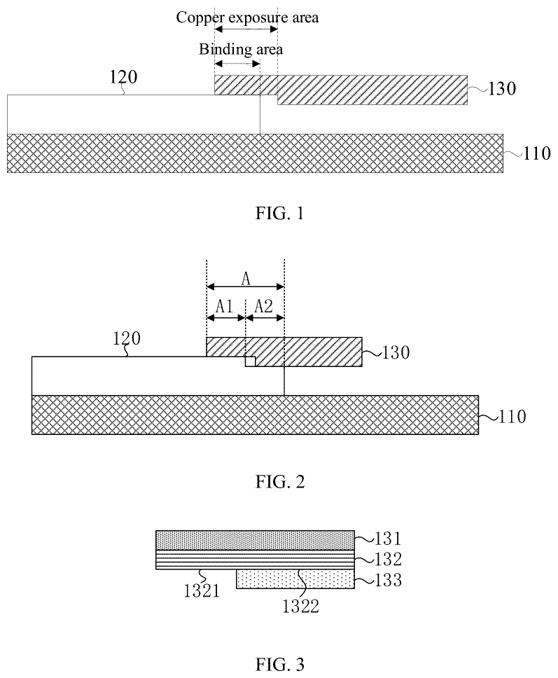

FIG. 1 is a cross-sectional view of a display panel provided by the prior art. As shown in FIG. 1, the display panel includes an array substrate 110, a cover plate 120 and a touch driver board 130. The array substrate 110 is a substrate integrated with a display module, the cover plate 120 is a transparent substrate integrated with a touch module, and the touch driver board 130 is a circuit board that drives the touch module to detect touch signals.

Specifically, the cover plate 120 is arranged on the array substrate 110, and the touch driver board 130 is arranged on a side of the cover plate 120 away from the array substrate 110. In order for the touch driver board 130 to be completely bound to the binding area of the cover plate 120, the length of the copper exposure area of the touch driver board 130 is generally set in the horizontal direction to be greater than the length of the binding area. Therefore, after the touch driver board 130 is bound to the binding area of the cover plate 120, there will be a part of the copper exposure area that is not bound to the binding area. In addition, the length of the array substrate 110 is greater than the length of the cover plate 120, so that the part of the copper exposure area that is not bound to the binding area cannot be coated with glue using the conventional back-side glue coating process due to the shielding of the array substrate 110, resulting in the part of the copper exposure area of the touch driver board 130 that is not bound to the binding area cannot prevent the corrosion of moisture and salt spray, thereby making the display panel poor in water resistance and salt spray resistance.

In view of the problem of poor water resistance and salt spray resistance of the display panel pointed out above, the embodiment of the present disclosure provides a display panel that can prevent moisture and salt spray from invading the display panel to improve the capability of the water resistance and salt spray resistance of the display panel.

FIG. 2 is a cross-sectional view of a display panel provided by an embodiment of the present application. Referring to FIG. 2, the display panel includes: an array substrate 110, a cover plate 120 and a touch driver board 130. The cover plate 120 is arranged on the array substrate 110. The side of the cover plate 120 away from the array substrate 110 includes a touch driver board binding area A. The touch driver board binding area A includes a first binding area A1 and a second binding area A2. The first binding area A1 and the second binding area A2 are arranged in a stepped mode. The touch driver board 130 includes a first conductive part and a second conductive part. The first conductive part is exposed, and the second conductive part is not exposed. The first conductive part is arranged in the first binding area A1 and part of the second binding area A2, and the second conductive part is arranged in the second binding area A2.

The touch driver board binding area A is an area where the cover plate 120 and the touch driver board 130 are bound. The first conductive part included in the touch driver board 130 is the exposed conductive layer of the touch driver board 130, and the second conductive part included in the touch driver board 130 is the unexposed conductive layer of the touch driver board 130. Thus, along the direction perpendicular to the cover plate 120, the thickness of the area of the touch driver board 130 including the second conductive part is greater than the thickness of the area of the touch driver board 130 including the first conductive part. The first binding area A1 and the second binding area A2 included in the touch driver board binding area A are arranged in a stepped mode. That is, the distance from the side of the second binding area A2 away from the array substrate 110 to the array substrate 110 is less than the distance from the side of the first binding area A1 away from the array substrate 110 to the array substrate 110, so that the second binding area A2 can accommodate the area of the second conductive part included in the touch driver board 130. Specifically, the first binding area A1 included in the touch driver board binding area A can realize the electrical connection between the cover plate 120 and the first conductive part, and the second binding area A2 included in the touch driver board binding area A can accommodate the part of the first conductive part that is not electrically connected to the cover plate 120 and the second conductive part, so that the part of the first conductive part that is not electrically connected to the cover plate 120 can be shielded by the second binding area A2, so as to mitigate the problem of being unable to prevent the portion of the first conductive part that is not electrically connected to the cover plate 120 from being corroded by moisture and salt spray due to directly exposure to the air, and further improve capability of the water resistance and the salt spray resistance of the display panel.

In summary, in the display panel provided by the embodiment of the present application, the cover plate 120 is disposed on the array substrate 110, and the side of the cover plate 120 away from the array substrate 110 includes a touch driver board binding area A. The touch driver board binding area A includes a first binding area A1 and a second binding area A2. The first binding area A1 and the second binding area A2 are arranged in a stepped mode. That is, the distance from the side of the second binding area A2 away from the array substrate 110 to the array substrate 110 is smaller than the distance from the side of the first binding area A1 away from the array substrate 110 to the array substrate 110. The touch driver board 130 includes a first conductive part and a second conductive part. The first conductive part is exposed, and the second conductive part is not exposed, so that along the direction perpendicular to the cover plate 120, the thickness of the area of the touch driver board 130 including the second conductive part is greater than the thickness of the area of the touch driver board 130 including the first conductive part. In addition, the first conductive part is arranged in the first binding area A1 and part of the second binding area A2, and the second conductive part is arranged in the second binding area A2, that is, the first binding area A1 can realize the electrical connection between the cover plate 120 and the first conductive part, and the second binding area A2 can accommodate the part of the first conductive part that is not electrically connected to the cover plate 120 and the second conductive part, so that the part of the first conductive part that is not electrically connected to the cover plate 120 can be shielded by the second binding area A2, so as to mitigate the problem of being unable to prevent the portion of the first conductive part that is not electrically connected to the cover plate 120 from being corroded by moisture and salt spray due to directly exposure to the air, and further improve capability of the water resistance and the salt spray resistance of the display panel.

On the basis of the above-mentioned embodiment, FIG. 3 is a cross-sectional view of a touch driver board provided by the embodiment of the present disclosure. Referring to FIG. 2 and FIG. 3, the touch driver board 130 includes a first insulating layer 131, a conductive layer 132 and a second insulating layer 133 stacked in sequence. The second insulating layer 133 covers part of the conductive layer 132. The first conductive part 1321 includes a conductive layer 132 not covered by the second insulating layer 133, and the second conductive part 1322 includes a conductive layer 132 covered by the second insulating layer 133. Along the direction from the first binding area A1 to the second binding area A2, the length of the first conductive part 1321 is greater than the length of the first binding area A1.

The first insulating layer 131 and the second insulating layer 133 can protect the conductive layer 132 from mechanical damage, chemical corrosion, moisture from contact with water vapor, and prevent electric shock from contact with conductors, which can enhance the strength of the touch driver board 130 and extend the service life of the touch driver board 130. The conductive layer 132 can realize the transmission of electrical signals between the touch driver board 130 and the cover plate 120.

Specifically, the touch driver board 130 is electrically connected to the cover plate 120 through the first conductive part. In order to ensure the stability of the electrical connection between the first conductive part of the touch driver board 130 and the first binding area A1 of the cover plate 120, that is, the stability of the binding between the first conductive part of the touch driver board 130 and the first binding area A1 of the cover plate 120, the length of the first conductive part of the touch driver board 130 is generally set in the direction from the first binding area A1 to the second binding area A2 to be greater than the length of the first binding area A1. Therefore, after the first conductive part 1321 is bound to the first binding area A1, part of the first conductive part 1321 will not be bound to the first binding area A1. The remaining first conductive part 1321 needs to be accommodated in the second binding area A2, so that the part of the first conductive part that is not electrically connected to the cover plate 120 is shielded by the second binding area A2, so as to mitigate the problem of being unable to prevent the portion of the first conductive part that is not electrically connected to the cover plate 120 from being corroded by moisture and salt spray due to directly exposure to the air, and further improve capability of the water resistance and the salt spray resistance of the display panel.

On the basis of the above embodiments, optionally, referring to FIG. 2 and FIG. 3, along the direction perpendicular to the cover plate 120, the step depth between the first binding area A1 and the second binding area A2 is greater than or equal to the thickness of the second insulating layer 133.

Specifically, since the second binding area A2 can accommodate the part of the first conductive part that is not electrically connected to the cover plate 120 and the second conductive part, and the first conductive part of equal length to the first binding area A1 is arranged in the first binding area A1, the first conductive part is flush with the side in contact with the first binding area A1. However, the second conductive part and the first conductive part are both the conductive layer 132 of the touch driver board 130, and the difference between the two is whether the second insulating layer 133 is arranged on the side facing the array substrate 110. In order to ensure that the side of the touch driver board 130 away from the cover plate 120 remains flush, along the direction perpendicular to the cover plate 120, the step depth between the first binding area A1 and the second binding area A2 needs to be set to be greater than or equal to the thickness of the second insulating layer 133. Thus, the second binding area A2 can accommodate the second conductive part, and the side of the touch driver board 130 away from the cover plate 120 can remain flush.

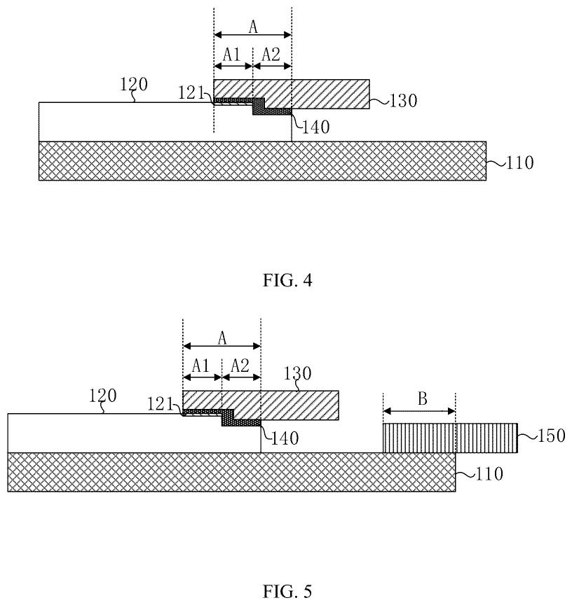

Based on the above embodiment, FIG. 4 is a cross-sectional view of another display panel provided in the embodiment of the present disclosure. Referring to FIG. 3 and FIG. 4, the display panel also includes a first conductive adhesive layer 140. The first conductive adhesive layer 140 covers the first binding area A1 and the second binding area A2. The first binding area A1 is provided with a first binding pin 121, and the first binding pin 121 is electrically connected to the first conductive part through the first conductive adhesive layer 140. Along the direction perpendicular to the cover plate 120, the sum of the thickness of the first conductive adhesive layer 140 covered by the first binding area A1 and the step depth between the first binding area A1 and the second binding area A2 is equal to the sum of the thickness of the second insulating layer 133 and the thickness of the first conductive adhesive layer 140 covered by the second binding area A2.

The first conductive adhesive layer 140 is an adhesive having a certain conductivity after curing or drying. It can connect the cover plate 120 and the touch driver board 130 together, so that a conductive path is formed between the cover plate 120 and the touch driver board 130. The first binding pin 121 is a pin electrically connected to the touch driver board 130 from the touch module provided inside the cover plate 120.

Specifically, the first conductive adhesive layer 140 covers the first binding area A1 and the second binding area A2, and the first binding area A1 is provided with the first binding pin 121, that is, the first conductive adhesive layer 140 covers the first binding pin 121 and the second binding area A2. Thus, the first binding pin 121 can be electrically connected to the first conductive part through the first conductive adhesive layer 140. The first conductive adhesive layer 140 can also fully fill the gap between the first binding area A1 and the first conductive part, the gap between the second binding area A2 and the first conductive part, and the gap between the second binding area A2 and the second insulating layer 133, so that the cover plate 120 and the touch driver board 130 are well bonded together. The first conductive adhesive layer 140 can also electrically connect all the first conductive parts to the first binding pin 121, further expanding the conductive area between the first conductive part and the first binding pin 121.

In addition, along the direction perpendicular to the cover plate 120, the sum of the thickness of the first conductive adhesive layer 140 covered by the first binding area A1 and the step depth between the first binding area A1 and the second binding area A2 is equal to the sum of the thickness of the second insulating layer 133 and the thickness of the first conductive adhesive layer 140 covered by the second binding area A2, so that the side of the touch driver board 130 away from the cover plate 120 can be kept flush with the horizontal plane.

On the basis of the above embodiments, optionally, FIG. 5 is a cross-sectional view of another display panel provided in an embodiment of the present disclosure. As shown in FIG. 5, the display panel also includes a display driver board 150. The side of the array substrate 110 on which the cover plate 120 is provided includes a display driver board binding area B. The display driver board 150 is provided in the display driver board binding area B. The touch driver board binding area A of the cover plate 120 is on the same side as the display driver board binding area B of the array substrate 110.

The display driver board 150 is a circuit board that drives the display module to emit light. The display driver board 150 is arranged in the display driver board binding area B, so that the display driver board 150 is electrically connected to the array substrate 110 to drive the array substrate 110 to display images. In addition, the touch driver board binding area A of the cover plate 120 can be arranged on the same side as the display driver board binding area B of the array substrate 110. That is, the display driver board 150 is on the same side as the touch driver board 130, thereby reducing the design volume of the display panel.

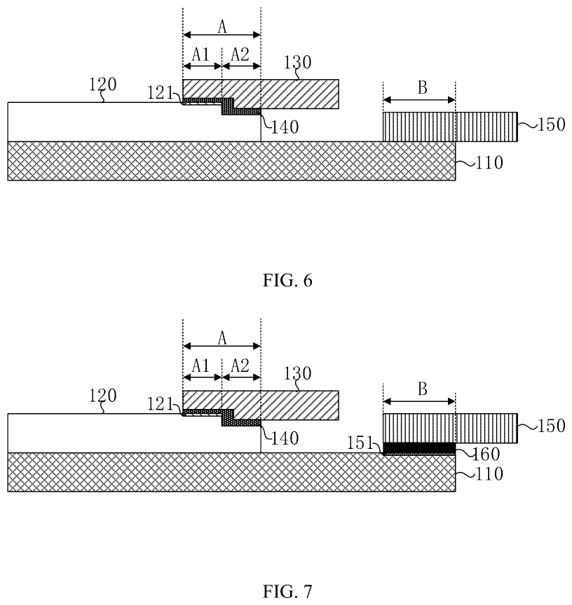

Based on the above embodiment, optionally, FIG. 6 is a top view of a display panel provided in an embodiment of the present disclosure. As shown in FIG. 6, in a direction perpendicular to the cover plate 120, the vertical projection of the touch driver board 130 does not overlap with the vertical projection of the display driver board 150.

Specifically, in the direction perpendicular to the cover plate 120, the vertical projection of the touch driver board 130 is set to not overlap with the vertical projection of the display driver board 150, which can avoid the touch driver board 130 and the display driver board 150 from being damaged and electrically connected. In addition, as compared with the vertical projection of the touch driver board 130 overlapping with the vertical projection of the display driver board 150, the vertical projection of the touch driver board 130 not overlap with the vertical projection of the display driver board 150 shows that the setting positions of the touch driver board 130 and the display driver board 150 are relatively dispersed, which is more conducive to the heat dissipation of the touch driver board 130 and the display driver board 150, so as to improve the service life of the touch driver board 130 and the display driver board 150.

Based on the above embodiment, optionally, FIG. 7 is a cross-sectional view of another display panel provided in the embodiment of the present disclosure. As shown in FIG. 7, the display panel also includes a second conductive adhesive layer 160. The display driver board 150 binding area is provided with a second binding pin 151. The second conductive adhesive layer 160 covers the display driver board binding area B, and the second binding pin is electrically connected to the display driver board 150 through the second conductive adhesive layer 160.

Specifically, the second conductive adhesive layer 160 is an adhesive having a certain conductivity after curing or drying. It can connect the array substrate 110 and the display driver board 150 together, so that a conductive path is formed between the array substrate 110 and the display driver board 150. The second binding pin is a pin electrically connected to the display driver board 150 from the display module set inside the array substrate 110.

Specifically, the second conductive adhesive layer 160 covers the display driver board binding area B, and the display driver board binding area B is provided with a second binding pin 121, that is, the second conductive adhesive layer 160 covers the second binding pin 121. Thus, the second conductive adhesive layer 160 not only realizes the electrical connection between the second binding pin and the display driver board 150, but also realizes the binding of the display driver board 150 to the display driver board binding area B.

For example, the display driver board includes a flexible circuit board.

Specifically, a flexible circuit board (FPC) is a highly reliable and excellently flexible printed circuit board made of polyimide or polyester film as a substrate. It has the characteristics of high wiring density, light weight, thin thickness, and good bendability. Therefore, the display driver board made of flexible circuit board has the characteristics of high wiring density, light weight, thin thickness, good bendability, etc.

For example, the touch driver board includes a transition flexible printed circuit.

Specifically, in the current display module industry, the transition flexible printed circuit (TFPC) used for module lighting can play the role of connecting the test motherboard, the fixture and the display module. Its function is to realize the transmission of electrical signals, and has the characteristics of high wiring density, light weight, thin thickness, good bendability, etc. Therefore, the touch driver board made of the transition flexible printed circuit can well transmit touch signals, and has the characteristics of high wiring density, light weight, thin thickness, good bendability, etc.

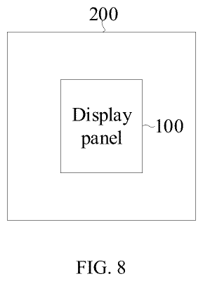

Based on the above embodiment, for example, FIG. 8 is a structural schematic diagram of a display device provided in an embodiment of the present disclosure. As shown in FIG. 8, the display device 200 includes the display panel 100 proposed in any embodiment of the present disclosure, and therefore has the beneficial effects of the display panel 100 provided in any embodiment of the present disclosure, which will not be repeated here.

It should be understood that the various forms of processes shown above can be used to reorder, add or delete steps. For example, the steps described in the present disclosure can be executed in parallel, sequentially, or in different orders, as long as the expected results of the technical solution of the present disclosure can be achieved, and it is not limited thereto.

The above specific implementation methods do not constitute a limitation on the scope of protection of the present disclosure. It should be understood by those skilled in the art that various modifications, combinations, sub-combinations and substitutions can be made according to design requirements and other factors. Any modifications, equivalent substitutions and improvements made within the spirit and principles of the present disclosure should be included in the scope of protection of the disclosure.

1. A display panel, comprising an array substrate, a cover plate and a touch driver board;
wherein the cover plate is arranged on the array substrate, and a side of the cover plate away from the array substrate comprises a touch driver board binding area, the touch driver board binding area comprises a first binding area and a second binding area, and the first binding area and the second binding area are arranged in a stepped mode; and
the touch driver board comprises a first conductive part and a second conductive part, the first conductive part is exposed, the second conductive part is not exposed, the first conductive part is arranged in the first binding area and part of the second binding area, and the second conductive part is arranged in the second binding area.

2. The display panel according to claim 1, wherein the touch driver board comprises a first insulating layer, a conductive layer and a second insulating layer stacked in sequence; the second insulating layer covers part of the conductive layer;
the first conductive part comprises the conductive layer not covered by the second insulating layer, and the second conductive part comprises the conductive layer covered by the second insulating layer; and
in a direction from the first binding area to the second binding area, a length of the first conductive part is greater than a length of the first binding area.

3. The display panel according to claim 2, wherein in a direction perpendicular to the cover plate, a step depth between the first binding area and the second binding area is greater than or equal to a thickness of the second insulating layer.

4. The display panel according to claim 2, wherein the display panel further comprises a first conductive adhesive layer, and the first conductive adhesive layer covers the first binding area and the second binding area;
the first binding area is provided with a first binding pin, and the first binding pin is electrically connected to the first conductive part through the first conductive adhesive layer;
in a direction perpendicular to the cover plate, a sum of a thickness of the first conductive adhesive layer covered by the first binding area and a step depth between the first binding area and the second binding area is equal to a sum of a thickness of the second insulating layer and a thickness of the first conductive adhesive layer covered by the second binding area.

5. The display panel according to claim 1, further comprising a display driver board;
wherein a side of the array substrate on which the cover plate is provided comprises a display driver board binding area, and the display driver board is provided in the display driver board binding area; and
the touch driver board binding area of the cover plate is on a same side as the display driver board binding area of the array substrate.

6. The display panel according to claim 5, wherein in a direction perpendicular to the cover plate, a vertical projection of the touch driver board does not overlap with a vertical projection of the display driver board.

7. The display panel according to claim 5, further comprising a second conductive adhesive layer; wherein the display driver board binding area is provided with a second binding pin; and
the second conductive adhesive layer covers the display driver board binding area, and the second binding pin is electrically connected to the display driver board through the second conductive adhesive layer.

8. The display panel according to claim 5, wherein the display driver board comprises a flexible circuit board.

9. The display panel according to claim 1, wherein the touch driver board comprises a transition flexible printed circuit.

10. A display device, comprising a display panel, wherein the display panel comprises:
an array substrate, a cover plate and a touch driver board;
wherein the cover plate is arranged on the array substrate, and a side of the cover plate away from the array substrate comprises a touch driver board binding area, the touch driver board binding area comprises a first binding area and a second binding area, and the first binding area and the second binding area are arranged in a stepped mode; and
the touch driver board comprises a first conductive part and a second conductive part, the first conductive part is exposed, the second conductive part is not exposed, the first conductive part is arranged in the first binding area and part of the second binding area, and the second conductive part is arranged in the second binding area.

11. The display device according to claim 10, wherein the touch driver board comprises a first insulating layer, a conductive layer and a second insulating layer stacked in sequence; the second insulating layer covers part of the conductive layer;
the first conductive part comprises the conductive layer not covered by the second insulating layer, and the second conductive part comprises the conductive layer covered by the second insulating layer; and
in a direction from the first binding area to the second binding area, a length of the first conductive part is greater than a length of the first binding area.

12. The display device according to claim 11, wherein in a direction perpendicular to the cover plate, a step depth between the first binding area and the second binding area is greater than or equal to a thickness of the second insulating layer.

13. The display device according to claim 11, wherein the display panel further comprises a first conductive adhesive layer, and the first conductive adhesive layer covers the first binding area and the second binding area;
the first binding area is provided with a first binding pin, and the first binding pin is electrically connected to the first conductive part through the first conductive adhesive layer;
in a direction perpendicular to the cover plate, a sum of a thickness of the first conductive adhesive layer covered by the first binding area and a step depth between the first binding area and the second binding area is equal to a sum of a thickness of the second insulating layer and a thickness of the first conductive adhesive layer covered by the second binding area.

14. The display device according to claim 10, further comprising a display driver board;
wherein a side of the array substrate on which the cover plate is provided comprises a display driver board binding area, and the display driver board is provided in the display driver board binding area; and
the touch driver board binding area of the cover plate is on a same side as the display driver board binding area of the array substrate.

15. The display device according to claim 14, wherein in a direction perpendicular to the cover plate, a vertical projection of the touch driver board does not overlap with a vertical projection of the display driver board.

16. The display device according to claim 14, further comprising a second conductive adhesive layer; wherein the display driver board binding area is provided with a second binding pin; and
the second conductive adhesive layer covers the display driver board binding area, and the second binding pin is electrically connected to the display driver board through the second conductive adhesive layer.

17. The display device according to claim 14, wherein the display driver board comprises a flexible circuit board.

18. The display device according to claim 10, wherein the touch driver board comprises a transition flexible printed circuit.
